(19) United States
(12) Patent Application Publication
(10) Pub. No.: US 2020/0107139 A1
(43) Pub. Date: Apr. 2, 2020

(54) METHOD FOR PROCESSING MICROPHONE SIGNALS IN A HEARING SYSTEM AND HEARING SYSTEM

(71) Applicant: SIVANTOS PTE. LTD., SINGAPUR (SG)

(72) Inventors: MARKO LUGGER, WEILERSBACH (DE); HOMAYOUN KAMKAR-PARSI, ERLANGEN (DE); MIRKO ARNOLD, KOENIGSBRONN (DE); ULRICH GIESE, FUERTH (DE)

(21) Appl. No.: 16/578,473

(22) Filed: Sep. 23, 2019

(30) Foreign Application Priority Data
Sep. 27, 2018 (DE) 10 2018 216 667.6

(51) Int. Cl. H04R 25/00; H04R 3/04; G10L 25/78

(52) U.S. Cl. CPC H04R 25/505; H04R 25/353; H04R 2225/43; G10L 25/78; H04R 3/04

(57) ABSTRACT

A hearing system has a hearing instrument that may be worn in or on a user's ear, and a peripheral device or a control program that may run on a data processing device. A microphone signal detected by the hearing instrument is examined for the user's own-voice components and is processed by a signal processor of the hearing instrument as a function of predetermined signal processing parameters. When own-voice components are detected, a first parameter set of the signal processing parameters is applied; when own-voice components are not detected, a second parameter set of the signal processing parameters is applied. The first parameter set may be modified by the user via the peripheral device or the control program in order to adapt the own-voice components contained in the microphone signal to a user-desired perception of the user's own voice.

### CROSS-REFERENCE TO RELATED APPLICATION

This application claims the priority, under 35 U.S.C. § 119, of German patent application DE 10 2018 216 667.6, filed Sep. 27, 2018; the prior application is herewith incorporated by reference in its entirety.

### BACKGROUND OF THE INVENTION

### Field of the Invention

The invention relates to a method for processing microphone signals in a hearing system that contains a hearing instrument that may be worn in or on the ear of a user. The invention also relates to a hearing system of this kind.

The term “hearing instrument” refers generally to an electronic device that records an ambient sound, modifies the signal and emits a modified sound signal to the hearing of a person wearing the hearing instrument (hereinafter referred to as the “user” or “wearer”).

A hearing instrument that is configured for the care of a hearing-impaired person and processes ambient acoustic signals, in particular amplifies these signals, in such a way that the hearing impairment is fully or partially compensated, is referred to here and hereinafter as a “hearing device.” To this end, a hearing device usually contains an input transducer, for example in the form of a microphone, a signal processing device with an amplifier, and an output transducer. The output transducer is typically implemented as a miniature loudspeaker and is also referred to as a “receiver.”

In addition to classical hearing devices, however, there are also hearing instruments that are configured to provide care for normal hearing people, to protect the respective user's hearing system or to support the user's sound perception for specific purposes (for example the understanding of speech in complex sound environments). Such hearing instruments are often similar in design to hearing devices and in particular comprise the aforementioned components: input transducer, signal processing device and output transducer.

In order to meet the numerous individualized requirements, different types of hearing instruments are available. In the case of what are known as behind-the-ear (BTE) hearing instruments, a housing equipped with the input transducer, signal processing means and a battery is worn behind the ear (between the skull and the auricle). Depending on the configuration, the receiver may be arranged either in the hearing device housing or directly in the user's ear canal (these are known as ex-receiver hearing instruments or receiver-in-the-canal (RIC) hearing instruments). In the first case, a flexible sound tube directs the receiver's acoustic output signals from the housing to the ear canal (tube hearing instruments). In the case of in-the-ear (ITE) hearing instruments, a housing containing all functional components including the microphone and the receiver is worn at least partially in the ear canal. Completely-in-canal (CIC) hearing instruments are similar to ITE hearing instruments, but are worn entirely in the ear canal.

Here and hereinafter, the term “hearing system” refers to an ensemble of devices and, where appropriate, other structures that provide the functions required for normal operation of the hearing instrument and thus form a functional unit. In the simplest case, such a hearing system may be configured as a single stand-alone hearing instrument. Typically, however, a hearing system consists of a plurality of devices. For example, in addition to a hearing instrument, the hearing system may contain another hearing instrument for the user's other ear and/or a peripheral device (for example a remote control or a programming device for programming the hearing instrument). Instead of a peripheral device, it is increasingly common for modern hearing systems to comprise a control program (i.e. a software application for controlling and, if necessary, programming the hearing instrument, in particular in the form of an “app”) that is or may be installed on a data processing device (for example, a computer or a mobile communication device, in particular a smartphone). For purposes of concision, such a control program of a hearing system is hereinafter also referred to as a “hearing application.” The data processing device is usually a multi-purpose device that is not specifically or selectively configured to interact with the hearing instrument and is usually manufactured and distributed independently of the hearing instrument. The data processing device is therefore usually not itself a part of the hearing system; rather, the hearing system uses it only as a resource for computing power, memory capacity and, if necessary, actuators and/or sensors.

An important factor for a (particularly hearing-impaired) user's acceptance of and lasting satisfaction with a hearing instrument is the subjective perception of the user's own voice. However, even with high-grade modern hearing instruments, the user's own voice as processed by the hearing instrument is often perceived as unnatural or unpleasant, which is detrimental to the initial acceptance of hearing instruments and above all makes it difficult for inexperienced users to become accustomed to the hearing instrument. Causing further difficulty, the settings of the signal processing in the hearing instrument that are optimal from the standpoint of the general sound perception and in particular the intelligibility of speech often come at the expense of the quality of the perceived the sound of the user's own voice.

With regard to this problem, when adapting (fitting) a hearing instrument to the individual user, attempts have usually been made to find the best possible compromise between the quality of own-voice perception and speech intelligibility (i.e. the intelligibility of the speech spoken by unfamiliar speakers). Alternatively, modem hearing instruments with own voice detection often offer the possibility of processing sound signals with own-voice components and sound signals without own-voice components in different ways. Accordingly, in such hearing instruments, signal processing may be advantageously optimized independently with regard to both good speech intelligibility and a pleasant sound of the user's own voice.

The use of both approaches, however, is limited chiefly by the fact that many users' perception of their own voice is subject to temporal fluctuations and trends that are individually different for each user—depending on the user's personality and physiological characteristics—and therefore cannot be taken into account in the course of an ordinary fitting process. In particular, the fitting is usually carried out by an audiologist outside the user's daily environment and therefore, due to the effort involved, frequent or short-term reactions are not possible.

### SUMMARY OF THE INVENTION

The object of the invention is to make possible an improved own-voice perception, in a hearing system and in a method for processing microphone signals in such a system.

With regard to a method for processing microphone signals in a hearing system of the type mentioned above, this object is accomplished according to the invention by the features of the main method claim. With regard to such a hearing system, this object is accomplished according to the invention by the features of the main apparatus claim 6. Advantageous configurations of the invention are set forth in the dependent claims and in the following description.

The method according to the invention is used to process microphone signals in a hearing system that contains a hearing instrument that may be worn in or on a user's ear and a peripheral device or a control program that may be run on a data processing device (i.e. a “hearing application”). The microphone signal is detected by the hearing instrument and is processed by a signal processing device as a function of predetermined (signal processing) parameters. In this case, the detected microphone signal is automatically examined for the user's own-voice components. The microphone signal is processed according to two different parameter sets, depending on whether the user's own-voice components are detected or not. For example, a first parameter set of the signal processing parameters is used when and while own-voice components are recognized, while a second parameter set of the signal processing parameters is used when and while own-voice components are not recognized.

According to the invention, the user may, via the peripheral device or control program, modify the first parameter set intended for processing the user's own-voice components in order to adapt the own-voice components contained in the microphone signal to a user-desired perception of the user's own voice.

The method thus enables the user to adjust the sound of the user's own voice flexibly and as needed, so that the sound of the user's own voice is perceived as pleasant by the user. The user may thus react to changes over time in the user's speech perception without having to seek an audiologist's assistance. These changes may thus be made quickly and easily. The user-made modifications to the first parameter set advantageously have a selective effect on microphone signals with own-voice components. The general sound perception and in particular the speech intelligibility that the hearing instrument conveys remain unaffected by user modifications to the first parameter set. As a result, the user is kept from (particularly unintentionally) degrading the hearing instrument's effectiveness with regard to general sound perception by making counterproductive parameter changes.

“Parameter set” generally denotes a data set that contains a respective value for each signal processing parameter or at least a subset of a plurality of selected signal processing parameters. The first parameter set and second parameter set represent different but similar data structures that may be stored and processed in the hearing system independently of each other. In particular, the respective contents of the two parameter sets may be defined and modified independently of each other. The contents of the first parameter set and the second parameter set are usually different, i.e. they have a different value for at least one of the signal processing parameters.

In the scope of the invention, in time periods where there is no own-voice component, a plurality of second parameter sets may also be used instead of a single second parameter set, so as to adapt the signal processing function to different classified hearing situations (for example music, speech of unfamiliar speakers, or the like).

The term “signal processing parameters” generally describes a magnitude that sets a certain signal processing function (i.e. defines it in qualitative and/or quantitative terms). Examples of such signal processing parameters are, in particular, a control parameter for the strength of noise suppression, a total amplification parameter for adjusting the overall volume of the sound signal output from the hearing instrument, and frequency-selective amplification factors for a plurality of frequency bands.

In a preferred configuration of the invention, the first parameter set contains a value for at least one signal processing parameter mentioned below:

a) a total amplification parameter, i.e. a parameter for adjusting a frequency-independent amplification of the microphone signal and/or a parameter for adjusting a dynamic compression characteristic (this parameter representing, for example, the position of one or a plurality of knee points of the compression characteristic curve); the user may modify the values of these parameters in order to adjust the perceived volume (loudness) of the user's own voice;
b) a number of frequency-specific amplification factors for different frequency components of the microphone signal (for example, three amplification factors for low, medium and high frequencies, each being independently adjustable in the manner of an equalizer) and/or a parameter with which the amplification of high and low frequencies is may be modified relative to one another (spectral balance); the user may modify the values of these parameters to adjust the perceived frequency distribution of the user's own voice,
c) a parameter (hereinafter “hardness parameter”) by the value of which the user may adjust the perceived “hardness” or “softness” of the sound of the user-perceived own voice; this parameter influences, for example, time constants and/or the strength of the dynamic compression; the functional relationship between the user-adjustable hardness parameter and the time constants or the strength of the dynamic compression is preferably determined in such a way that the time constants of the dynamic compression are set to be greater and/or the strength of the dynamic compression is more reduced the harder the sound of the user's own voice is intended to be (a hard sound of the user's own voice is caused in this case by the compression being applied with comparatively long delay and/or low strength; while a soft sound of the user's own voice, in contrast, is generated through strong compression and/or a compression occurring with only a small delay); the relationship between the hardness parameter and the time constants or the strength of the dynamic compression is optionally varied as a function of the level of the user's own voice.

Preferably, a plurality of the above-mentioned signal processing parameters are user-adjustable, so that the user may vary the sound of the user's own voice in a multidimensional parameter space. In advantageous embodiments of the invention, the signal processing parameters that span this parameter space are chosen in such a way that redundant sound settings are avoided, i.e. so that the user's own voice sounds different at every selectable point of the parameter space.

As part of the hearing system, the user is provided with a corresponding control, for example in the form of a slider control or rotary knob for setting each modifiable signal processing parameter of the first parameter set. In the context of the invention, if the signal processing parameters of the first parameter set are adjustable via a peripheral device of the hearing system, the or each control device may be configured as an electromechanical component. In particular, in the case of embodiments of the invention in which the signal processing parameters of the first parameter set may be set via a hearing application, the controls are preferably configured as control elements of a graphical user interface (GUI), which, by way of example, are based on corresponding electromechanical components, for example slider controls or rotary knobs.

The hearing system according to the invention contains a hearing instrument and a peripheral device or a control program that may be run on a data processing device (“hearing application”). The hearing instrument contains at least one microphone for detecting a microphone signal, a signal processing device for processing the recorded microphone signal depending on predetermined signal processing parameters, and an own-voice recognition module for recognizing the user's own-voice components in the microphone signal.

The hearing system is generally devised so as to carry out the above-described method according to the invention. Specifically, the signal processing of the hearing instrument is arranged so as to process the microphone signal as described above as a function of the detection or non-detection of own-voice components in the microphone signal, according to a first or second parameter set of signal processing parameters.

According to the invention, the first parameter set may be modified via the peripheral device or the hearing application in order to adapt the own-voice components in the microphone signal to a user-desired perception of the user's own voice. In particular, the peripheral device or hearing application has at least one control element that enables the user to modify the first parameter set.

Signal processing preferably takes place in the hearing instrument, for example, in a digital signal processor (DSP). This signal processor contains, in an advantageous embodiment, a programmable module, such as a microprocessor, in which the functionality of the signal processing or a part thereof is implemented in software form. In addition or alternatively, in an advantageous embodiment the signal processor contains a non-programmable unit, for example an ASIC, in which the signal processing functionality or a part thereof is implemented in the form of hardware circuits.

In principle, however, in the context of the invention, it is also conceivable that the peripheral device of the hearing system or the hearing application is set up to carry out the signal processing or part thereof.

All individual embodiments and variants of the method according to the invention correspond to corresponding embodiments and variants of the hearing system according to the invention, and vice versa. The above-described advantages of the individual embodiments of the method according to the invention, accordingly, apply analogously to the corresponding embodiments of the hearing system according to the invention.

Other features which are considered as characteristic for the invention are set forth in the appended claims.

Although the invention is illustrated and described herein as embodied in a method for processing microphone signals in a hearing system and a hearing system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The single FIGURE of the drawing is schematic representation of a hearing system with a hearing instrument configured as a hearing device.

### DETAILED DESCRIPTION OF THE INVENTION

Referring now to the single FIGURE of the drawing in detail, therein is shown a hearing system 1 with a hearing instrument configured as a hearing device 3.

The hearing device 3, which here is configured as a BTE device by way of example and is accordingly worn behind a user's ear, contains two microphones 5, a receiver 7 and a battery 9. The hearing device 3 additionally contains a signal processing device 11 with an own-voice recognition module 13. The signal processing device 11 is in particular configured as a digital signal processor (DSP), which is configured as a programmable electronic component or at least contains such a component. The own-voice recognition module 13 is preferably configured as a software module implemented in the DSP 11.

When the hearing device 3 is in operation, the microphones 5 pick up a sound signal from the environment of the hearing device 3 and transmit the signal to the signal processing device 11 in the form of an audio signal (i.e. an electrical signal that carries sound information). The audio signal is referred to below as a microphone signal. In the signal processing device 11, the microphone signal is modified by a plurality of signal processing algorithms. In particular, the signal processing device 11 preferably contains a plurality of amplifier stages for amplifying the microphone signal that are connected in series, some of which are frequency-selective and some frequency-independent, and which may be set independently of each other. The signal processing device 11 sends a modified audio signal to the receiver 7. The receiver 7 converts the modified audio signal into an output sound signal that is emitted into the user's ear canal via a sound tube (not shown).

The functionality of the signal processing algorithms implemented in the signal processing device 11 is determined in more detail by a multiplicity, for example approximately 150, of (signal processing) parameters p₁, p₂, p₃, . . . . By way of example, these parameters are as follows:

a) parameter p₁ is a total amplification factor by which an overall volume of the output sound signal is adjusted, i.e. frequency-independently;
b) parameter p₂ is a “spectral balance,” by which a ratio is set between an amplification factor for high-frequency components (trebles) of the microphone signal and an amplification factor for low-frequency components (basses) of the microphone signal—the volume of the output sound signal remaining constant—and by means of which the perceived pitch of the output sound signal may thus be modified; parameter p₂ in this case is in particular converted to the frequency-specific amplification factors of a greater number of frequency bands of the signal processing device 11 (for example, in an exemplary embodiment of the signal processing device 11 having 32 frequency bands, the individual amplification factors of the 16 low-frequency bands are increased or decreased by the parameter p₂ relative to the individual amplification factors of the 16 high-frequency bands),
c) parameter p₃ is a “hardness control variable,” by which the sound of the output sound signal is adjusted in relation to the perceived “hardness” or “softness”; the parameter p₃ influences, for example via a predetermined mathematical function, the value of the time constants of the dynamic compression; in a simple but expedient embodiment, the time constants are varied proportionally to the value of parameter p₃ (in this case, the (hardness) parameter p₃ is defined such that large values of this parameter p₃ correspond to a hard sound, while small values of this parameter p₃ correspond to a soft sound).

A memory (not otherwise shown) of the hearing device 3 contains at least a first parameter set P_{OV} and a second parameter set P_{NOV}, which may be used alternatively to assign different values to the signal processing parameters p₁, p₂, p₃, . . . .

When the hearing device 3 is in use, the microphone signal is examined by the own-voice recognition module 13 for the user's own-voice components. The own-voice recognition module 13 outputs a signal OV indicating the recognition or non-detection of own-voice components. The signal processing device 11 applies one of the two parameter sets P_{OV} and P_{NOV} as a function of this signal OV. If the signal OV indicates the detection of own-voice components, the signal processing device 11 applies the first parameter set P_{OV}, so that the signal processing algorithms of the signal processing means 11 are parameterized with the values of this first parameter set P_{OV}. Otherwise, if the signal OV indicates the non-detection of own-voice components, the signal processing device 11 applies the second parameter set P_{NOV}, so that the signal processing algorithms of signal processing device 11 are parameterized with the values of the second parameter set P_{NOV}.

The signal processing device 11 thus processes the microphone signal differently when the user is speaking, compared to time intervals in which the microphone signal does not contain any own-voice components. The parameter set P_{OV} defines a certain point in a three-dimensional parameter space—namely a space spanned by the parameters p₁, p₂ and p₃—and with respect to the output sound signal:

the volume of the user's own voice may be varied by varying the value of parameter p₁,
the pitch of the user's own voice may be varied by varying the value of parameter p₂,
the timbre (i.e. the perceived hardness or softness) of the user's own voice may be varied by varying the value of parameter p₃, and each parameter being varied independently of the others.

In addition to the hearing device 3, the hearing system 1 contains a control program for controlling the hearing device 3, which in its intended use is installed on a user's smartphone 15 (which is not itself part of the hearing system 1). The control program is referred to below as a hearing application 17.

The smartphone 15 is coupled to the hearing device 3 via a wireless data transmission connection, for example based on the Bluetooth standard, so that the hearing application 17 may exchange data bidirectionally with the hearing device 3 by accessing a transmitter-receiver unit (in particular a Bluetooth transceiver) of the smartphone 15. The hearing application 17 also contains a graphical user interface (GUI) that may be displayed on a screen of the smartphone 15.

The hearing application 17 manages a copy of the P_{OV} parameter set, which the hearing application 17 stores in a memory of the smartphone 15. The graphical user interface contains a number of control elements that may be displayed as graphical symbols and which the user may use to modify the copy of the P_{OV} parameter set stored in the smartphone 4. In principle, embodiments of the invention are conceivable in which the user is able to modify all the parameter values of the P_{OV} parameter set. In embodiments that are simplified and therefore more manageable for non-specialist users, however, the hearing application 17 is preferably configured in such a way that it only allows modifying a single parameter value or a plurality of selected parameter values of the first parameter set P_{OV}. In an advantageous embodiment, the hearing application 17 only permits modifying the values of parameters p₁, p₂ and p₃ contained in the parameter set P_{OV}.

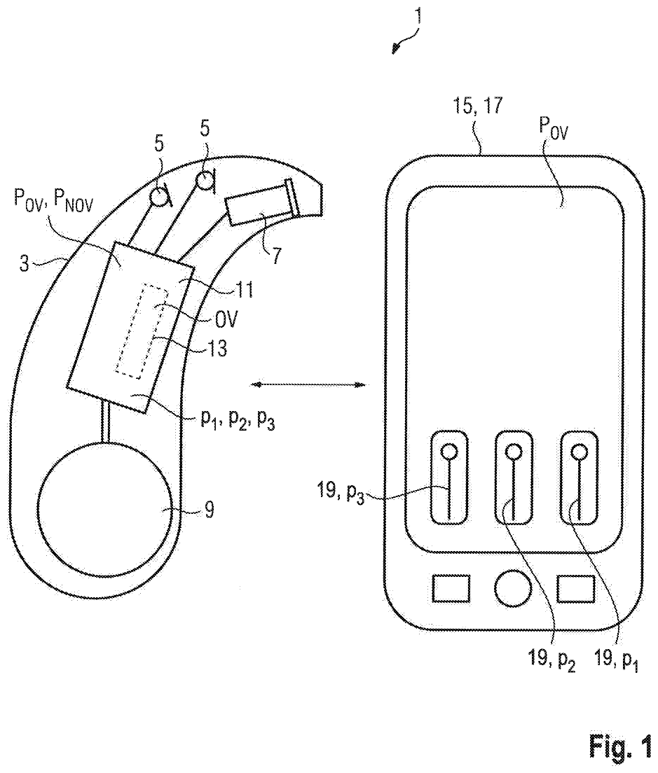

The graphical user interface of the hearing application 17 contains three controls 19, depicted by way of example as sliders in FIG. 1.

If the user modifies the value of the corresponding parameter p₁, p₂ or p₃ by manipulating one of the controls 19, the hearing application 17 accordingly updates the copy of the parameter set P_{OV} stored in the smartphone 15 with the modified parameter value. Moreover, the hearing application 17 also transmits the updated parameter set P_{OV} to the hearing device 3, where the updated parameter set P_{OV} is likewise stored, via the wireless data transmission link, and thus determines the future signal processing in time intervals with own-voice components. In this way, the user may flexibly adjust the sound of the user's own voice as conveyed by the hearing device 3 to the user-desired perception at any time. The user's modifications are limited to the periods in which the user is speaking. These changes thus do not influence the signal processing of the hearing device 3 in time intervals that do not have own-voice components. In particular, the user cannot inadvertently degrade the intelligibility of speech made possible by the hearing device 3 (i.e. the intelligibility of the speech of unfamiliar speakers processed by the hearing device 3).

Although the invention is made particularly clear in the exemplary embodiment described above, it is not limited to this exemplary embodiment. Rather, additional embodiments of the invention may be derived from the claims and the above description.

For example, in one variant of the exemplary embodiment shown, instead of the separate controls 19 for modifying the values of the parameters p₂ and p₃, a two-dimensional control surface is furnished, on which certain p₂ and Pa values, as a measure of sound quality, may be selected simultaneously.

In another variant of the exemplary embodiment shown, the P_{OV} parameter set does not contain values for all signal processing parameters of the hearing device 3, but only values for the selected parameters p₁, p₂, p₃, which the user may modify via the hearing application 17. Accordingly, in this variant only these modifiable parameter values are exchanged between the hearing application 17 and the hearing device 3. In this case, values for additional signal processing parameters are stored separately in the hearing device 3.

In other embodiments of the invention, in turn, control elements for modifying the first parameter set P_{OV} (as part of a graphical user interface or in the form of electromechanical command devices) are contained in a peripheral device of the hearing system 1 that may be present, such as for example a remote control.

The following is a summary list of reference numerals and the corresponding structure used in the above description of the invention:
1 Hearing system
3 Hearing device
5 Microphone
7 Receiver
9 Battery
11 Signal processing means
13 Own-voice recognition module
15 Smartphone
17 Hearing application
19 Control
p₁ (Signal processing) parameters
p₂ (Signal processing) parameters
p₃ (Signal processing) parameters
OV Signal
P_{OV} (first) parameter set
P_{NOV} (second) parameter set

1. A method for processing a microphone signal in a hearing system having a hearing instrument that may be worn in or on an ear of a user and a peripheral device or a control program that may run on a data processing device, which comprises the steps of:
detecting the microphone signal with the hearing instrument;
processing a detected microphone signal by a signal processor in dependence on predetermined signal processing parameters;
automatically determining if the detected microphone signal contains own-voice components of the user;
processing the detected microphone signal according to a first parameter set of the predetermined signal processing parameters when the own-voice components are detected and according to at least a second parameter set of the predetermined signal processing parameters when the own-voice components are not detected; and
modifying the first parameter set by the user via the peripheral device or the control program to adapt the own-voice components contained in the detected microphone signal to a user-desired perception of a user's own voice.

2. The method according to claim 1, wherein the first parameter set comprises:
a value for a parameter for adapting a frequency-independent amplification of the detected microphone signal; and/or
a value for a parameter for adapting a characteristic curve of a dynamic compression, wherein either of the values may be modified by the user in order to adjust a perceived volume of the user's own voice.

3. The method according to claim 1, wherein the first parameter set comprises:
respectively an associated value for a number of frequency-specific amplification factors for the detected microphone signal; and/or
a value for a parameter with which an amplification of high-frequency components of the detected microphone signal and an amplification of low-frequency components of the detected microphone signal may be modified relative to one another, wherein the user is able to modify either of the value or the associated value in order to adapt a perceived frequency distribution to the user's own voice.

4. The method according to claim 1, wherein the first parameter set contains a value for a parameter, and the user is able to modify the value to adjust a perceived hardness or softness of a sound of a voice of the user.

5. The method according to claim 1, which further comprises outputting the detected microphone signal processed by the signal processor via the hearing instrument.

6. A hearing system, comprising:
a hearing instrument that may be worn in or on an ear of a user;
a peripheral device or with a control program that is capable of running on a data processor;
said hearing instrument having at least one microphone for detecting a microphone signal, a signal processor for processing the microphone signal detected in dependence on predetermined signal processing parameters, and an own-voice recognition module for examining the microphone signal for own-voice components of the user;
said signal processor is adapted to carry out a processing of the microphone signal as follows:
when the own-voice components are recognized according to a first parameter set of the predetermined signal processing parameters;
when the own-voice components are not recognized according to at least one second parameter set of the predetermined signal processing parameters; and
wherein the first parameter set may be modified by the user by means of said peripheral device or said control program in order to adapt the own-voice components contained in the microphone signal to a user-desired perception of a voice of the user.

7. The hearing system according to claim 6, wherein said hearing instrument further has a receiver for outputting the microphone signal processed by said signal processor.
